(19) United States
(12) Patent Application Publication
(10) Pub. No.: US 2026/0245903 A1
(43) Pub. Date: Aug. 20, 2026

(54) Lithium Metal Cell With Polymeric Lithium Salt Doped Electrodes

(71) Applicant: APPLE INC., Cupertino, CA (US)

(72) Inventors: Alan A. Ritchie, Menlo Park, CA (US); Andrew Basile, Santa Clara, CA (US); Karl M. Brown, Los Gatos, CA (US); Malar A. Azagarsamy, Fremont, CA (US)

(21) Appl. No.: 19/530,993

(22) Filed: Feb. 5, 2026

Related U.S. Application Data
(60) Provisional application No. 63/758,540, filed on Feb. 14, 2025.

(51) Int. Cl. H01M 4/62; H01M 4/04; H01M 4/13; H01M 4/139; H01M 10/052; H01M 10/0565

(52) U.S. Cl. CPC H01M 4/62; H01M 4/0404; H01M 4/13; H01M 4/139; H01M 10/052; H01M 10/0565; H01M 2300/0082

(57) ABSTRACT

A lithium metal electrochemical cell has a cathode having a cathode active material layer made from a cathode slurry. The cathode slurry has a cathode active material, a cathode solvent having a first donor number, and a cathode lithium salt having a first melting point. The lithium metal electrochemical cell also has an anode and an electrolyte having an electrolyte solvent having a second donor number and an electrolyte lithium salt having a second melting point. The first donor number is greater than the second donor number and the first melting point is greater than the second melting point.

### CROSS-REFERENCE TO RELATED APPLICATIONS

This application claims the benefit of, and priority to, United States Provisional Application No. 63/758,540, filed on February 14, 2025. The contents of the foregoing application is hereby incorporated by reference herein in its entirety for all purposes.

### TECHNICAL FIELD

This disclosure relates to lithium metal cells with polymeric lithium salt doped electrodes, the lithium salt in the electrodes having limited solubility in the liquid electrolyte.

### BACKGROUND

Additives may be used to improve the performance of a lithium metal electrochemical cell. These additives may be used to improve the cathode electrolyte interphase (CEI) or the solid electrolyte interphase (SEI) with the lithium metal. Yet the additives are often introduced through the liquid electrolyte, thereby disseminating the additive throughout the cell, diminishing its impact on the electrode for which it is added and potentially having a negative impact on the other electrode.

### SUMMARY

Disclosed herein are implementations of lithium metal cells with polymeric lithium salt doped electrodes, the lithium salt in the electrodes having limited solubility in the liquid electrolyte. Implementations include a cathode doped with a polymeric lithium salt and, in certain implementations, an anode having a protective layer doped with a polymeric lithium salt.

In an implementation, a lithium metal electrochemical cell has a cathode having a cathode active material layer made from a cathode slurry. The cathode slurry has a cathode active material, a binder, a cathode solvent having a first donor number, and a cathode lithium salt having a first melting point. The lithium metal electrochemical cell also has an anode and an electrolyte having an electrolyte solvent having a second donor number and an electrolyte lithium salt having a second melting point. The first donor number is greater than the second donor number and the first melting point is greater than the second melting point.

In an implementation, a lithium metal electrochemical cell has a cathode having a cathode active material layer made from a cathode slurry. The cathode slurry comprises a cathode active material, a binder, a cathode solvent, and a cathode lithium salt. The lithium metal electrochemical cell further has an anode and an electrolyte. The electrolyte comprises an electrolyte solvent different from the cathode solvent and an electrolyte lithium salt different from the cathode lithium salt. The cathode lithium salt is soluble in the cathode solvent but is less soluble in the electrolyte solvent.

In some implementations, the anode of the lithium metal electrochemical cell comprises a polymer electrolyte lamination layer made from a slurry comprising an anode solvent having a third donor number, an anode lithium salt having a third melting point, and a crosslinked polymer having a molecular weight of between 400,000 g/mol and 900,000 g/mol. The third donor number is greater than the second donor number and the third melting point is greater than the second melting point.

In an implementation, a cathode for a lithium metal electrochemical cell has a cathode current collector and a cathode material on the cathode current collector. The cathode material comprises a cathode active material, a binder, and a cathode lithium salt. The cathode lithium salt resides in the binder, the binder attaching to surfaces of the cathode active material and spanning between cathode active material particles.

Also disclosed is a method of making the cathode. The method includes forming a slurry by dissolving the cathode lithium salt in a cathode solvent and thereafter, mixing in the cathode active material and the binder. The cathode is fabricated by coating the slurry onto the cathode current collector and evaporating the cathode solvent.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is flow diagram of a method of making a cathode as disclosed herein.

FIG. 2 is a graph comparing cycle life of lithium metal electrochemical cells having cathodes fabricated as disclosed herein compared to a conventional cathode.

FIG. 3 is a graph illustrating the impact of higher concentrations of the cathode lithium salt on the cycle life of the lithium metal electrochemical cell.

FIG. 4 is an image from an electron microscope showing LiDFOB in the binder between and spanning the cathode active material layer particles.

FIG. 5 is a graph showing the effect on impedance with different amounts of LiBOB in the polymer electrolyte lamination layer of the anode as disclosed herein.

FIG. 6 is a graph showing the negative effect on impedance of LiDFOB on a lithium metal electrochemical cell.

FIG. 7 is a schematic of a lithium metal electrochemical cell as disclosed herein.

### DETAILED DESCRIPTION

Cathode additives may be used, for example, to improve a lithium metal electrochemical cell’s stability and performance by forming a protective layer on the cathode surface, preventing the dissolution of transition metals from the cathode material, and mitigating the loss of lithium ions during the charging cycles. Anode additives may be used, for example, to stabilize the lithium metal surface, prevent the formation of dendrites, and enhance the stability of the solid electrolyte interphase layer that forms on the anode during operation. The additives may lead to better cycle life and capacity retention of the battery. A cathode additive may have no benefit to the lithium metal in the anode or may even have a negative impact on the anode. An anode additive, likewise, may have no impact on the cathode or may even have a negative impact on the cathode. Yet these additives have been added to the battery in the liquid electrolyte. The liquid electrolyte carries these additives throughout the lithium metal electrochemical cell rather than targeting the electrode for which the additive was added.

Furthermore, some additives that may improve the performance of the lithium metal electrochemical cell by providing advantages to one of the cathode or the anode have been found to insufficiently dissolve into the liquid electrolyte solvent. When the additive does not sufficiently dissolve in the solvent, the amount of additive available to provide its benefits is reduced.

Disclosed herein are lithium metal electrochemical cells having a polymer lithium salt cathode additive that that provides a robust CEI on the cathode active material that protects the cathode active material from over-reaction with the electrolyte and over-growth of impedance during cycling, increasing lithium metal electrochemical cell cycle life by 20% to 30%. The polymer lithium salt cathode additive resides in and is maintained within the binder of the cathode material, the binder with the polymer lithium salt cathode additive attaching to cathode surfaces and spanning between adjacent cathode active material particles to form the CEI. The polymer lithium salt cathode additive remains in the cathode compartment as it is held in the binder of the cathode material, having no impact on the anode. The polymer lithium salt cathode additives disclosed herein have limited solubility in the electrolyte solvent, so the polymer lithium salt cathode additive does not leach into the electrolyte solvent. Rather, this limited solubility in the liquid electrolyte solvent assists in activating the polymer lithium salt cathode additive to assist in the formation of the CEI. Because the polymer lithium salt cathode additive does not completely dissolve in the electrolyte solvent, it remains in the cathode compartment and does not move through the separator to the anode.

The cathode for a lithium metal electrochemical cell as disclosed herein has a cathode current collector and a cathode material on the cathode current collector. The cathode material comprises cathode active material, a binder, and a cathode lithium salt (the polymer lithium salt cathode additive). Other materials may be present, such as carbon to improve conductivity. The cathode lithium salt resides in the binder, the binder attaching to surfaces of the cathode active material and spanning the space between cathode active material particles.

A lithium metal electrochemical cell disclosed herein has a cathode having a cathode active material layer made from a cathode slurry. The cathode slurry has a cathode active material, a binder, a cathode solvent having a first donor number, and a cathode lithium salt having a first melting point. The lithium metal electrochemical cell also has an anode and an electrolyte having an electrolyte solvent having a second donor number and an electrolyte lithium salt having a second melting point. The first donor number is greater than the second donor number and the first melting point is greater than the second melting point.

To achieve the benefits realized by the inventors, it has been found that the cathode lithium salt must be one that creates a robust CEI in the cathode, must be soluble in the cathode solvent, and must have limited solubility in the electrolyte solvent. Lithium salts with higher lattice energies have lower solubility or ionic dissociation in a solvent. Melting points for ionic compounds are directly correlated to their lattice energies, meaning the higher the melting point, the higher the lattice energy and the stronger the ionic bonds requiring more energy to dissociate. Therefore, the melting point of the cathode lithium salt is higher than the melting point of the electrolyte lithium salt, which are necessarily different lithium salts. Conventional electrolyte lithium salts include lithium bis(fluorosulfonyl)imide (LiFSI), with a melting point of 145ºC, and lithium hexafluorophosphate (LiPF₆), with a melting point of 200ºC. The cathode lithium salts disclosed herein have melting points greater than 250ºC. The cathode lithium salts disclosed herein that meet the requisites determined by the inventors are lithium difluorooxalatoborate (LiDFOB), lithium tetrafluoroborate (LiBF₄), LiDBFOP, lithium nitrate (LiNO₃), lithium dicyanamide (LiDCA), lithium nitride (Li₃N), lithium triflate (LiOTf) and combinations thereof. Respective melting points are 265ºC, 296ºC, 340ºC, 264ºC, about 260ºC, 830ºC, and 300ºC. This list is not inclusive and other materials that function to create a robust CEI while being soluble in the cathode solvent and have limited solubility in the electrolyte solvent are contemplated.

The binder is typically polyvinylidene fluoride (PVDF) but is not limited to such.

The electrolyte comprises an electrolyte solvent different from the cathode solvent and, as noted, an electrolyte lithium salt different from the cathode lithium salt. The cathode lithium salt is soluble in the cathode solvent but is less soluble in the electrolyte solvent. The cathode solvent, also known as a casting solvent, is a strong solvent as it must dissolve the binder and the cathode lithium salt. N-methyl-2-pyrrolidone (NMP) is a conventional cathode solvent, but the cathode solvent is not limited to NMP. The cathode solvents used in the disclosed cathode have a higher donor number than the donor number of the electrolyte solvent. The donor number is a quantitative measure of a solvent's ability to donate electron pairs, essentially indicating its Lewis basicity, and is typically determined by measuring the negative enthalpy change when a solvent interacts with a standard Lewis acid in a non-coordinating solvent. A higher donor number signifies a stronger electron donor ability of the solvent. The cathode solvent must effectively dissolve the binder to hold the cathode active material and other components together on the current collector during the manufacturing process. NMP has a doner number of 27. Conventional electrolyte solvents have lower donor numbers. For example, dimethyl carbonate (DMC) has a donor number of 17.2, ethyl methyl carbonate (EMC) and ethylene carbonate (EC) have donor numbers of 16, and 1,2-dimethoxyethane (DME) has donor number of 20. The cathode solvent used herein has a donor number (first donor number) of 25 or greater, greater than the donor number (second donor number) of the electrolyte solvent. Other examples of cathode solvents include, but are not limited to, dimethyl sulfoxide (DMSO) and dimethylacetamide (DMAc), with donor numbers of 29.8 and 27.8, respectively.

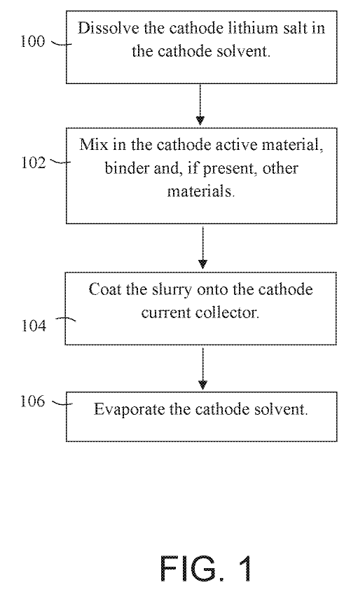

To obtain the benefits achieved with the disclosed cathode lithium salts, a method of making the cathode is also disclosed. As shown in FIG. 1, the method includes forming a slurry by dissolving the cathode lithium salt in a cathode solvent in step 100 and thereafter, mixing in the cathode active material and the binder in step 102. The cathode is fabricated by coating the slurry onto the cathode current collector in step 103 and evaporating the cathode solvent in step 104. Using this method, the cathode lithium salt is distributed throughout the binder and after evaporation of the cathode solvent, the cathode lithium salt resides in the binder, the binder attaching to surfaces of the cathode active material and spanning between cathode active material particles. In the fabricated lithium metal electrochemical cell, the liquid electrolyte has access to the cathode lithium salt at the point of interest, the cathode interface. The cathode lithium salt forms a robust CEI on surfaces of the cathode active material particles, stabilizing the cathode interface. Some of the cathode lithium salt will be consumed during the CEI formation, but additional cathode lithium salt remains near the interface to be accessed as needed during the operation of the cell. Constraining the cathode lithium salt at the point of use increases the lithium metal electrochemical cell performance, increasing cycles by 20% to 30%.

Also disclosed herein are lithium metal electrochemical cells having the cathodes disclosed herein and anodes comprising a polymer electrolyte lamination layer as taught in United States Patent No. 11,728,547, incorporated herein. The anode of the lithium metal electrochemical cell comprises a polymer electrolyte lamination layer made from a slurry comprising an anode solvent having a third donor number, an anode lithium salt having a third melting point, and a crosslinked polymer having a molecular weight of between 400,000 g/mol and 900,000 g/mol. The third donor number of the anode solvent is greater than the second donor number of the electrolyte solvent and the third melting point of the anode lithium salt is greater than the second melting point of the electrolyte lithium salt. The donor number of the anode solvent is 25 or greater.

As with the cathode lithium salt, the anode lithium salt dissolves in the anode solvent but is less soluble in the electrolyte solvent, having limited solubility in the electrolyte solvent. The anode lithium salt is maintained in the polymer electrolyte lamination layer and does not leach into the separator and cathode as it does not dissolve in the electrolyte solvent. The anode lithium salt acts as an SEI former during the anode assembly and continues this function during cell operation as the anode lithium salt remains in the polymer electrolyte lamination layer of the anode.

The anode lithium salt is different from the cathode lithium salt as the disclosed materials benefit one anode while having less benefit, or no benefit, to the other. The melting point of the anode lithium salt is greater thana the melting point of the electrolyte lithium salt. The anode lithium salts are, as non-limiting examples, one or a combination of lithium bis(oxalato)borate (LiBOB), lithium tetrafluoroborate (LiBF₄), and lithium perchlorate (LiClO₄).

The cross-linked polymer may be selected from the group consisting of a crosslinked poly(vinylidene fluoride)-co-hexafluoropropylene (PVDF-HFP), a crosslinked polyethylene glycol dimethacrylate (PEGDMA), crosslinked polydiallyldimethylammonium chloride (polyDDA), crosslinked polyvinyl butyral (PVB), crosslinked poly(urethane acrylate) (PUA), crosslinked polyethylene glycol (PEO), crosslinked polyacrylonitrile (PAN), crosslinked poly(methyl methacrylate) (PMMA), or copolymers thereof. The crosslinked polymer backbone may be a polyelectrolyte, a polymeric salt that has a cationic or an anionic backbone, such as lithiated Nafion®, a sulfonated tetrafluoroethylene based fluoropolymer-copolymer, and poly(lithium styrene sulfonate). The crosslinked polymer backbone can be one polymer or can be a mixture of more than one polymer. Crosslinking can be achieved by both chemical crosslinking (during synthesis) and physical crosslinking (such as the dissociated lithium salt coordination with the polymer’s fluorine atoms).

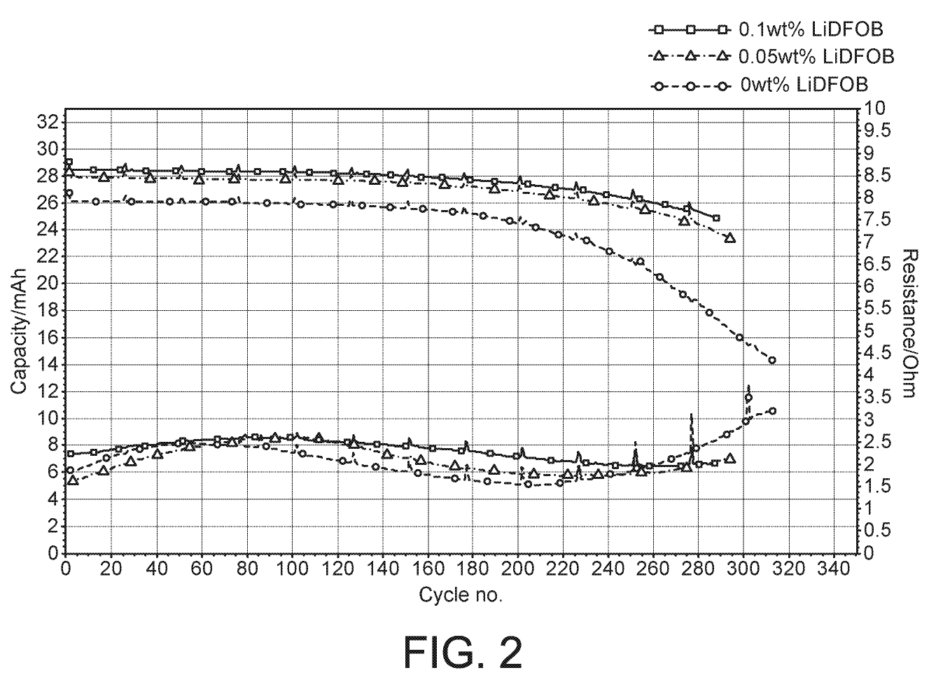

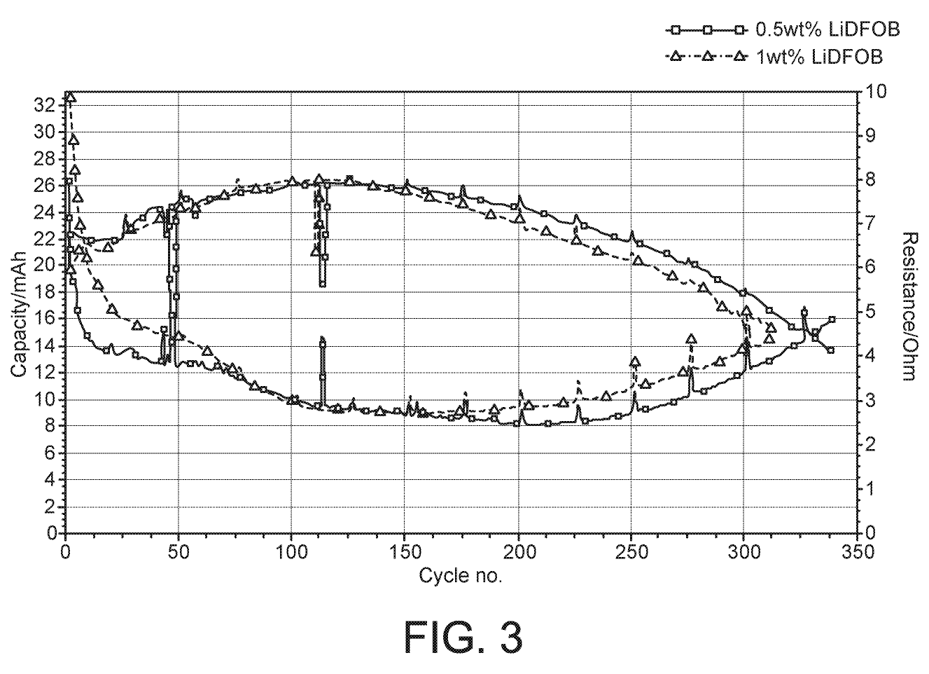

Cathodes were made by the method as disclosed herein using LiCoO₂ as the cathode active material, PVDF as the binder, NMP as the solvent and carbon black. In one example, 0.1wt% of LiDFOB was added. In a second example, 0.05wt% of LiDFOB was added. In a comparative example, no LiDFOB was used. As illustrated in FIG. 2, the two examples with the LiDFOB achieved significantly higher cycles while maintaining capacity as compared to the comparative example. In a third example, 0.5wt% of LiDFOB was added, and in a fourth example, 1.0wt% of LiDFOB was added. As illustrated in FIG. 3, the higher amounts of LiDFOB in the third and fourth examples created impedance, causing performance similar to or worse than the comparative example. Significant performance improvements are realized when the cathode lithium salt is LiDFOB and the weight percent of the LiDFOB in the cathode slurry, or the pre-cast cathode material, is greater than or equal to 0.01 wt% and less than 0.5 wt%, or more particularly greater than or equal to 0.05 wt% and less than or equal to 0.3 wt%.

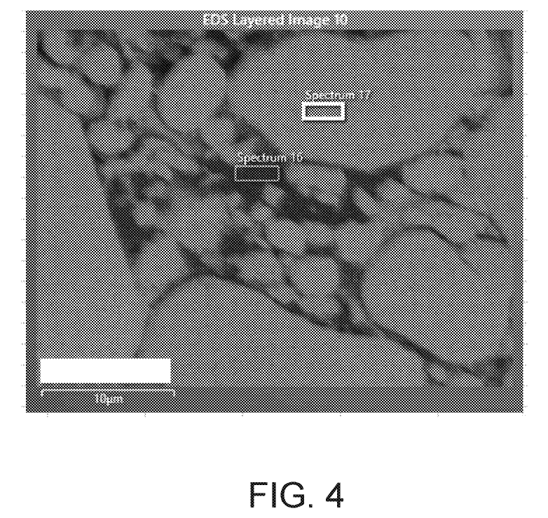

FIG. 4 is an image taken with an electron microscope of the cathode material in the first example, with 0.1wt% of LiDFOB. The microscope picked up the boron that is in the LiDFOB. In the image, the lighter material (denoted as Spectrum 17) is LiCoO₂ and the dark material surrounding the cathode active material (denoted as Spectrum 16) is the boron in the LiDFOB. The image confirms that dissemination of the LiDFOB throughout the binder, surrounding the particle surfaces and spanning the particles.

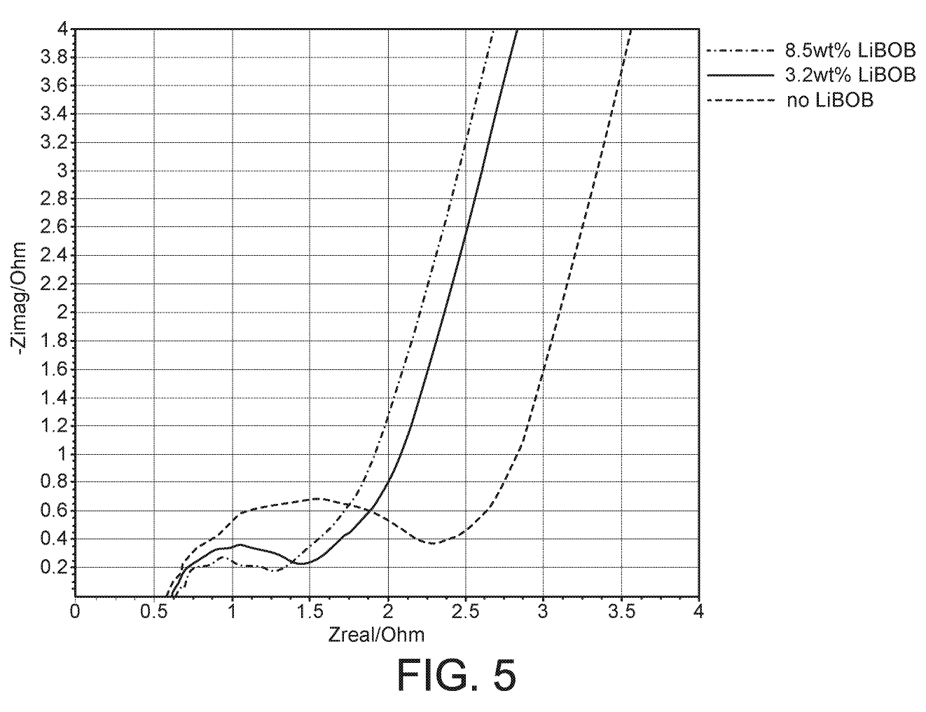

Lithium metal electrochemical cells were fabricated with polymer electrolyte lamination layers in the anode as disclosed herein, as taught in United States Patent No. 11,728,547. The cross-linked polymer was 33 wt% crosslinked PVDH-HFP copolymer. The anode solvent was DMAc. In a first example, 3.2wt% of LiBOB was used, and in a second example, 8.5wt% of LiBOB was used. As illustrated in FIG. 5, the cell impedance is significantly improved in both examples incorporating the LiBOB compared with the example using no LiBOB in the polymer electrolyte lamination layer.

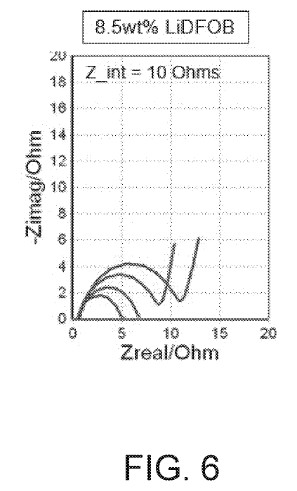

As previously discussed, the cathode additive may have no benefit to the lithium metal in the anode or may even have a negative impact on the anode. The anode additive, likewise, may have no impact on the cathode or may even have a negative impact on the cathode. This is another reason why it is important to keep the electrode lithium salt in its respective electrode. For example, while LiDFOB has been shown herein to have significant impact on a lithium metal electrochemical cell’s cycle life when used in the cathode, it has a negative impact when used in the anode. FIG. 6 is a graph illustrating the impact of using LiDFOB in place of LiBOB in the polymer electrolyte lamination layer of the anode. The cell impedance increases significantly. Note the scale of the x-axis in FIG. 6 is ten times that in FIG. 5. LiDFOB when used at the anode significantly increases the cell’s impedance. Using the method herein, the LiDFOB can be maintained in the cathode, achieving all of the benefits of the cathode additive without diminishing them with the negative impact on the anode.

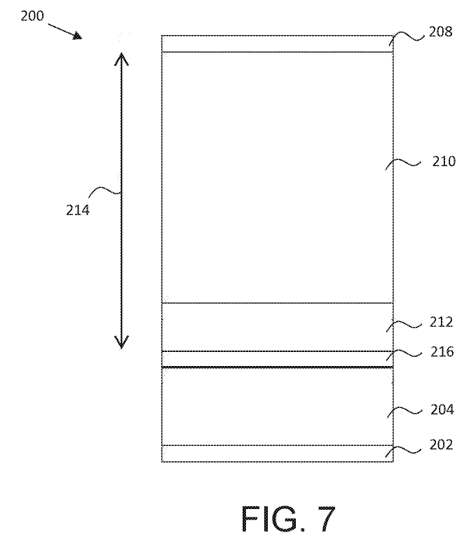

FIG. 7 is an electrochemical cell 200, the layers of which are shown in cross-section. The electrochemical cell 200 has an anode current collector 202 and an anode active material 204 disposed on the anode current collector 202. The electrochemical cell 200 also has a cathode current collector 208 and a cathode active material layer 210 as disclosed herein disposed on the cathode current collector 208. The cathode active material layer 210 and the anode active material 204 are separated by a separator 212, and the liquid electrolyte 214 is represented with the arrow. The polymer electrolyte lamination layer 216 as disclosed herein bonds the separator 212 and the anode active material 204.

The cathode current collector 208 can be, for example, an aluminum sheet or foil. Cathode active material in the cathode active material layer 210 can include one or more lithium transition metal oxides which can be bonded together using binders and optionally conductive fillers such as carbon black. Lithium transition metal oxides can include, but are not limited to, LiCoO_{2,} LiNiO_{2,} LiNi_{0.8}Co_{0.15}Al_{0.05}O₂, LiMnO₂, Li(Ni_{0.5}Mn_{0.5})O₂, LiNixCoyMnzO₂, Spinel Li₂Mn₂O₄, LiFePO₄ and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄.

The anode active material 204 is lithium metal. The anode active material 204 can include both a lithium metal seed layer and plated lithium. The anode active material 204 is not otherwise particularly limited, and can comprise lithium alloys, lithium-containing metal oxides, lithium-containing metal sulfides, lithium-containing metal nitrides, carbonaceous materials such as graphite, and combinations thereof. The anode current collector 202 can be a copper, nickel or titanium sheet or foil, as a non-limiting example.

The separator 212 is a porous, tortuous mechanical layer or membrane that physically separates the cathode active material from the polymer electrolyte lamination layer and other layers of the stack. The separator can be between 0.1 µm and 30 µm in thickness and may be composed of a single layer or multi-layer of organic or inorganic materials, such as polyolefins and glass fibers, respectively. The separator may be single or double sided coated with organic (e.g., polyvinylidene fluoride (PVdF)) and/or inorganic (e.g., magnesium hydroxide (Mg(OH)₂)) materials. The single sided separator coating may preferably be a coating at the cathode side. Alternatively, the separator coating at the cathode side may be provided by a coating on the cathode, rather than a coating on the separator.

The liquid electrolyte 214 can be composed of at least one lithium salt (e.g., LiFSI) dissolved in at least one organic solvent (e.g. DMC) or inorganic liquid solvent. The liquid electrolyte 214 may contain at least one ionic liquid (e.g., Py13FSI) and may contain organic and inorganic additives.

Lithium metal batteries are disclosed and comprise multiple lithium metal electrochemical cells 200.

It is to be understood that the terminology used herein is used for the purpose of describing particular embodiments only and is not intended to limit the scope of the disclosure. It must be noted that as used herein and in the appended claims, the singular forms "a," "an," and "the" include the plural reference unless the context clearly dictates otherwise. Thus, for example, a reference to "an element" is a reference to one or more elements and includes equivalents thereof known to those skilled in the art. Unless defined otherwise, all technical and scientific terms used herein have the same meanings as commonly understood by one of ordinary skill in the art to which this invention belongs.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A lithium metal electrochemical cell, comprising:
a cathode having a cathode active material layer made from a cathode slurry, the cathode slurry comprising:
a cathode active material;
a binder;
a cathode solvent having a first donor number; and
a cathode lithium salt having a first melting point; and
an electrolyte comprising:
an electrolyte solvent having a second donor number; and
an electrolyte lithium salt having a second melting point; and
an anode,
wherein the first donor number is greater than the second donor number and the first melting point is greater than the second melting point.

2. The lithium metal electrochemical cell of claim 1, wherein the first donor number is greater than 25 and the first melting point is greater than 250ºC.

3. The lithium metal electrochemical cell of claim 1, wherein the cathode lithium salt is LiDFOB, LiBF₄ LiDBFOP, LiNO₃ LiDCA, Li₃N, LiOTf and combinations thereof.

4. The lithium metal electrochemical cell of claim 1, wherein the cathode lithium salt is LiDFOB and a weight percent of the LiDFOB in the cathode slurry is greater than or equal to 0.01 wt% and less than 0.5 wt%.

5. The lithium metal electrochemical cell of claim 1, wherein the anode comprises a polymer electrolyte lamination layer made from a slurry comprising:
an anode solvent having a third donor number;
an anode lithium salt having a third melting point; and
a crosslinked polymer having a molecular weight of between 400,000 g/mol and 900,000 g/mol,
wherein the third donor number is greater than the second donor number and the third melting point is greater than the second melting point.

6. The lithium metal electrochemical cell of claim 5, wherein the third donor number is greater than 25.

7. The lithium metal electrochemical cell of claim 5, wherein the crosslinked polymer is selected from the group consisting of crosslinked PVDF-HFP, crosslinked PEGDMA, crosslinked polyDDA, crosslinked PVB, crosslinked PUA, crosslinked PEO, crosslinked PAN, crosslinked PMMA, and copolymers thereof.

8. The lithium metal electrochemical cell of claim 5, wherein the anode solvent is DMAc and the anode lithium salt is LiBOB.

9. The lithium metal electrochemical cell of claim 8, wherein the cathode lithium salt is LiDFOB and a weight percent of the LiDFOB in the cathode slurry is greater than or equal to 0.01 wt% and less than 0.5 wt%.

10. A lithium metal electrochemical cell, comprising:
a cathode having a cathode active material layer made from a cathode slurry, the cathode slurry comprising:
a cathode active material;
a binder;
a cathode solvent; and
a cathode lithium salt; and
an electrolyte comprising:
an electrolyte solvent different from the cathode solvent; and
an electrolyte lithium salt different from the cathode lithium salt; and
an anode,
wherein the cathode lithium salt is soluble in the cathode solvent and is less soluble in the electrolyte solvent.

11. The lithium metal electrochemical cell of claim 10, wherein the cathode lithium salt is LiDFOB, LiBF₄ LiDBFOP, LiNO₃ LiDCA, Li₃N, LiOTf and combinations thereof.

12. The lithium metal electrochemical cell of claim 10, wherein the cathode lithium salt is LiDFOB and a weight percent of the LiDFOB in the cathode slurry is greater than or equal to 0.01 wt% and less than 0.5 wt%.

13. The lithium metal electrochemical cell of claim 10, wherein the anode comprises a polymer electrolyte lamination layer made from a slurry comprising:
an anode solvent;
an anode lithium salt different from the cathode lithium salt and the electrolyte lithium salt; and
a crosslinked polymer having a molecular weight of between 400,000 g/mol and 900,000 g/mol,
wherein the anode lithium salt is soluble in the anode solvent but is less soluble in the electrolyte solvent.

14. The lithium metal electrochemical cell of claim 13, wherein the crosslinked polymer is selected from the group consisting of crosslinked PVDF-HFP, crosslinked PEGDMA, crosslinked polyDDA, crosslinked PVB, crosslinked PUA, crosslinked PEO, crosslinked PAN, crosslinked PMMA, and copolymers thereof.

15. The lithium metal electrochemical cell of claim 13, wherein the anode solvent is DMAc and the anode lithium salt is LiBOB.

16. The lithium metal electrochemical cell of claim 15, wherein the cathode solvent is NMP, the cathode lithium salt is LiDFOB, and the electrolyte lithium salt is LiFSI.

17. A cathode for a lithium metal electrochemical cell, the cathode comprising:
a cathode current collector; and
a cathode material on the cathode current collector, the cathode material comprising:
a cathode active material;
a binder; and
a cathode lithium salt, wherein the cathode lithium salt resides in the binder, the binder attaching to surfaces of the cathode active material and spanning between cathode active material particles.

18. The cathode of claim 17, wherein the cathode lithium salt is LiDFOB, LiBF₄ LiDBFOP, LiNO₃ LiDCA, Li₃N, LiOTf and combinations thereof.

19. The cathode of claim 17, wherein the cathode lithium salt is LiDFOB and a weight percent of the LiDFOB in a pre-cast cathode material is greater than or equal to 0.01 wt% and less than 0.5 wt%.

20. The cathode of claim 19, wherein the weight percent of the LiDFOB in the pre-cast cathode material is greater than or equal to 0.05 wt% and less than or equal to 0.3 wt%.

21. A method of making the cathode of claim 17, comprising:
forming a slurry by:
dissolving the cathode lithium salt in a cathode solvent; and
thereafter, mixing in the cathode active material and the binder; and
fabricating the cathode by:
coating the slurry onto the cathode current collector; and
evaporating the cathode solvent.
